(19) United States
(12) Patent Application Publication
(10) Pub. No.: US 2026/0288527 A1
(43) Pub. Date: Sep. 24, 2026

(54) BI-LEVEL MACHINE-LEARNING-ASSISTED MANAGEMENT OF COMPUTING RESOURCES

(71) Applicant: Microsoft Technology Licensing, LLC, Redmond, WA (US)

(72) Inventors: Yu YAN, Issaquah, WA (US); Pinghe LI, Zurich (CH); Zibo WANG, Beijing (CN); Chieh-Jan Mike LIANG, Beijing (CN)

(21) Appl. No.: 19/475,748

(22) PCT Filed: May 12, 2023
(86) PCT No.: PCT/CN2023/093808

§ 371 Date: Oct. 15, 2025

(51) Int. Cl. G06F 9/50; G06N 20/00

(52) U.S. Cl. CPC G06F 9/5027; G06N 20/00; G06F 2209/501; G06F 2209/503

(57) ABSTRACT

A bi-level machine learning (“ML”)-assisted framework for resource management is provided that includes an application-level controller that operates in concert with a service-level controller to scale the allocation of a computing resource to a network service in a manner that satisfies a service-level objective (“SLO”) . The application-level controller utilizes a ML model to learn a performance target that is transmitted to the service-level controller. The service-level controller adjusts the allocation of the computing resource to the network service based on the performance target and resource utilization data associated with the network service.

### BACKGROUND

Cloud-native applications are commonly architected around the use of distributed network services. As the number of network services used by an application increases, managing the computing resources used by the application can become a challenging task. For instance, many cloud-native applications are interactive and user-facing and, therefore, require low end-to-end latency in order to ensure a positive user experience. As a result, the management of computing resources utilized by latency-sensitive applications typically involves minimizing the amount of computing resources allocated to the network services that provide the application while, at the same time, also satisfying a maximum latency requirement, such as a service-level objective (“SLO”).

Previous approaches to resource management for cloud-native applications that are architected around the use of distributed network services utilize either distributed or centralized strategies based on heuristics or machine learning. These approaches, however, fall short in practicality with respect to optimal resource allocation and low operation overheads. For example, distributed approaches to resource management commonly achieve sub-optimal resource allocation due to the lack of visibility into end-to-end latencies and applicable SLOs. Centralized approaches can be less responsive to bursty network workloads due to the challenges of distributed tracing and real-time logging at scale.

While machine learning (“ML”)-based techniques may provide improved performance as compared to hand-crafted heuristics, ML-based techniques commonly impose a significant training overhead that can negate any realized resource savings. ML-based techniques can also require costly retraining following changes to service topology or workload.

It is with respect to these and other technical challenges that the disclosure made herein is presented.

### SUMMARY

Technologies are disclosed herein for ML-assisted management of computing resources. Through implementations of the disclosed technologies, savings can be achieved in the utilization of computing resources (e.g., central processing unit (“CPU”) time) as compared to previous heuristic and ML-based approaches. Implementations of the disclosed technologies also provide other technical benefits as compared to previous resource management solutions such as, for example, not requiring costly retraining following changes to service topology or workload as required by previous ML-based approaches to resource management. Other technical benefits, some of which are described below, can also be realized through implementations of the disclosed subject matter.

In one embodiment, a bi-level ML-assisted framework for resource management is provided that decouples the mechanisms of SLO feedback and resource control. The bi-level ML-assisted framework includes an application-level ML-based controller (which might be referred to herein as the “application-level controller”) that operates in concert with a service-level heuristic-based controller (which might be referred to herein as the “service-level controller”) to scale the allocation of a computing resource (e.g., CPUs) to a network service in a manner that satisfies an SLO.

The application-level controller utilizes a ML model to learn a performance target, or targets, utilized by instances of a network service in a distributed application to maintain a SLO. The ML model is a reinforcement learning ML model in various embodiments disclosed herein. In some embodiments, the reinforcement learning ML model is a contextual bandits ML model.

In an embodiment, the ML model learns the performance target based on the SLO, attributes of a time-varying network workload, and resource allocation data that describes a current allocation of a computing resource to a network service. In an embodiment, the SLO defines a maximum latency for providing responses to requests in the network workload. In this embodiment, the attributes of the network workload utilized by the ML model include a workload measure that defines an average number of requests per second (“RPS”) in the network workload and latency statistics defining an average latency for providing responses to requests in the network workload during a previous time period (e.g., the previous second).

The managed computing resource is a CPU utilized by the network service in one embodiment. In this embodiment, the performance target is a CPU throttle target and the resource utilization data describes a current CPU throttle count for the CPU upon which the network service is executing. The resource allocation data describes the current allocation of the CPU to the network service.

The service-level controller receives the performance target from the application-level controller. The service-level controller then adjusts the allocation of the computing resource (e.g., CPU) to the network service based on the performance target and the resource utilization data associated with the network service.

In an embodiment, for instance, the service-level controller performs a comparison between the resource utilization data associated with the network service and the performance target and adjusts the allocation of the computing resource to the network service based on results of the comparison. For example, the service-level controller can increase (i.e., scale up) the allocation of the computing resource to the network service when the resource utilization data exceeds the performance target. The service-level controller can decrease (i.e., scale down) the allocation of the computing resource to the network service when the resource utilization data does not exceed the performance target.

As discussed briefly above, implementations of the technologies disclosed herein provide various technical benefits such as reducing the utilization of computing resources (e.g., CPUs) and eliminating the need to retrain a ML model following changes to service topology or workload as required by previous ML-based approaches to resource management. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a network and computing system architecture diagram showing aspects of the configuration and operation of an illustrated framework that provides functionality for ML-assisted management of computing resources, according to one embodiment disclosed herein;

FIG. 1B is a network and computing system architecture diagram showing aspects of the configuration and operation the framework shown in FIG. 1A, according to another embodiment disclosed herein;

FIG. 2 is a flow diagram showing a routine that illustrates additional aspects of the operation of an application-level ML-based controller shown in FIGS. 1A and 1B, according to one embodiment disclosed herein;

FIG. 3 is a flow diagram showing a routine that illustrates additional aspects of the operation of a service-level heuristic-based controller shown in FIGS. 1A and 1B, according to one embodiment disclosed herein;

FIG. 4 is a flow diagram showing a routine that illustrates aspects of the operation of the service-level heuristic-based controller shown in FIGS. 1A and 1B for scaling up the allocation of a computing resource to a network service, according to one embodiment disclosed herein;

FIG. 5 is a flow diagram showing a routine that illustrates additional aspects of the operation of the service-level heuristic-based controller shown in FIGS. 1A-1B for scaling down the allocation of a computing resource to a network service, according to one embodiment disclosed herein;

FIG. 6 is a flow diagram showing a routine that illustrates aspects of a mechanism for rolling back operations performed during an inadvertent scale down of the allocation of a network resource, according to one embodiment disclosed herein;

FIG. 7 is a computer architecture diagram showing an illustrative computer hardware and software architecture for a processing system that can implement aspects of the technologies presented herein; and

FIG. 8 is a network diagram illustrating a distributed computing environment in which aspects of the disclosed technologies can be implemented.

### DETAILED DESCRIPTION

The following detailed description is directed to technologies for ML-assisted management of computing resources. As discussed briefly above, various technical benefits can be realized through implementations of the disclosed technologies such as reducing the utilization of computing resources (e.g., CPUs) and not requiring retraining following changes to service topology or workload as required by previous ML-based approaches to resource management. Other technical benefits, some of which are described below, can also be realized through implementations of the disclosed subject matter.

Those skilled in the art will appreciate that the subject matter described herein can be practiced with various computer system configurations, including hand-held devices, multiprocessor systems, microprocessor-based or programmable consumer electronics, computing or processing systems including those embedded in devices (such as wearable computing devices, automobiles, home automation, etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for ML-assisted management of computing resources will be described.

As discussed briefly above, cloud-native applications are commonly architected around the use of distributed network services. As the number of network services used by an application increases, managing the computing resources (e.g., CPUs) used by the network services and other components that implement the application can become a challenging task. For instance, many cloud-native applications are user-facing and, therefore, require low end-to-end latency in order to ensure a positive user experience. As a result, the management of computing resources utilized by latency-sensitive applications typically involves minimizing the amount of allocated computing resources while, at the same time, also satisfying a maximum latency requirement, such as a SLO.

Previous approaches to resource management for cloud-native applications that are architected around the use of distributed network services utilize either distributed or centralized strategies based on heuristics or machine learning. These approaches, however, fall short in practicality with respect to optimal resource allocation and low operation overheads. For example, distributed approaches commonly achieve sub-optimal resource allocation due to the lack of visibility into end-to-end latencies and applicable SLOs. Centralized approaches can be less responsive to bursty network workloads due to the challenges of distributed tracing and real-time logging at scale.

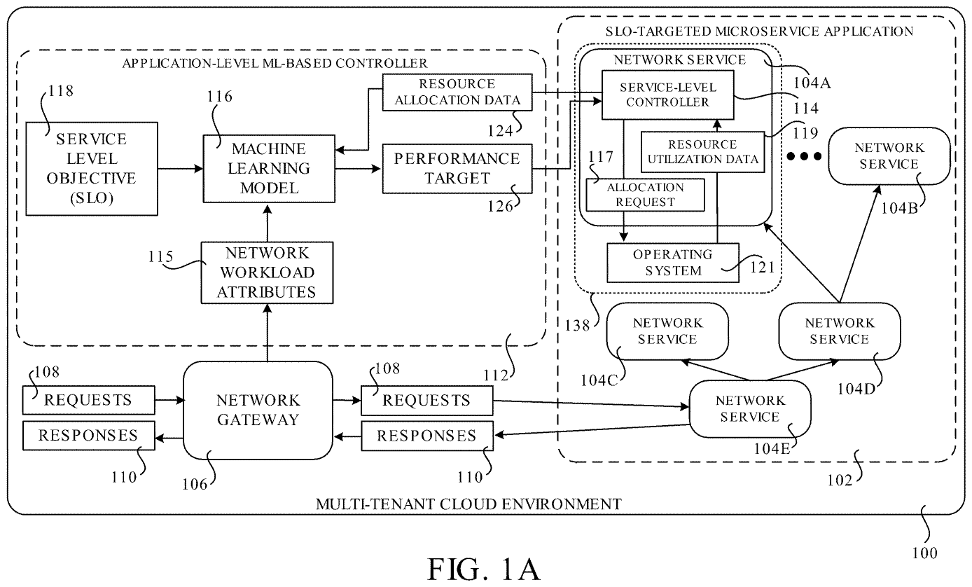

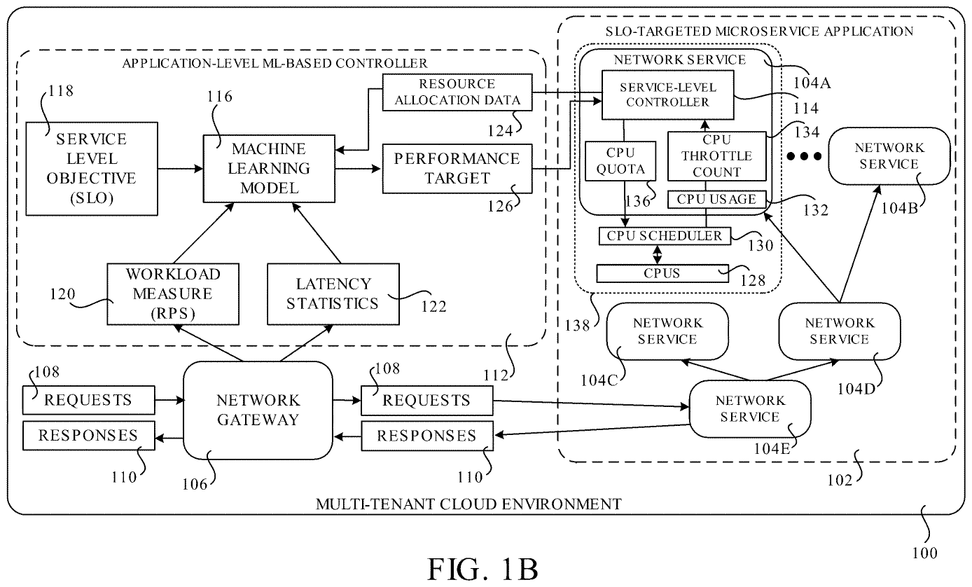

ML-based resource management techniques may provide improved performance as compared to hand-crafted heuristics; however, ML-based techniques commonly impose a significant training overhead that can negate any realized resource savings. ML-based techniques can also require costly retraining following changes to service topology or workload. The technologies disclosed below with regard to FIGS. 1A-6 address these and other technical considerations.

FIGS. 1A and 1B are network and computing system architecture diagrams showing aspects of the configuration and operation of a framework that provides functionality for ML-assisted management of computing resources, according to one embodiment disclosed herein. As shown in FIGS. 1A and 1B, and discussed briefly above, the disclosed framework is implemented within a multi-tenant cloud environment 100, in one embodiment. The multi-tenant cloud environment 100 is a network computing architecture that allows groups of users, commonly referred to as “tenants,” to share computing resources in a public or private cloud. Each tenant's data is isolated by the multi-tenant cloud environment 100 and remains invisible to other tenants.

In multi-tenant cloud environments such as that shown in FIGS. 1A and 1B, applications are commonly implemented utilizing a topology of interconnected network services, which are also commonly referred to as microservices. In the embodiment illustrated in FIGS. 1A and 1B, for example, an SLO-targeted microservice application 102 (the “application 102”) has been implemented in the multi-tenant cloud environment 100 utilizing a collection of network services 104A-104E that operate together to implement aspects of the functionality provided by the application 102.

The application 102 is SLO-targeted in that the performance of the application 102 is measured by a pre-defined SLO 118. The SLO 118 defines a targeted level of service and is commonly expressed as a percentage over a period of time. In an embodiment, the SLO 118 defines a maximum latency for providing responses 110 to requests 108 in a time-varying network workload directed to the application 102. In this regard, it is to be appreciated that while the embodiments disclosed herein are primarily presented with respect to an SLO 118 relating to network latency, other SLOs 118 can be defined relating to other measurable aspects of the performance of the application 102 and the network services 104 utilized to implement the application 102.

As discussed briefly above, it can be technically challenging to operate an application 102 in a manner that satisfies an SLO 118 while at the same time minimizing the utilization of computing resources, such as CPUs, memory, power, network bandwidth, and others. The technologies disclosed herein address this, and other technical challenges, by providing a bi-level ML-assisted framework for resource management that decouples the mechanisms of SLO feedback and resource control. Details regarding the framework are provided below.

In an embodiment, the bi-level ML-assisted framework includes an application-level ML-based controller 112 (which might be referred to herein as the “application-level controller 112”) that operates in concert with a service-level heuristic-based controller 114 (which might be referred to herein as the “service-level controller 114”) to scale the allocation of a computing resource to network services 104A-104E (which might be referred to herein collectively as “the network services 104”) in a manner that satisfies an SLO 118. As shown in FIGS. 1A and 1B, an instance of the service-level controller 114 operates with each instance of the network services 104, in an embodiment.

As will be discussed in greater detail herein, the application-level controller 112 utilizes a ML model 116 to periodically (e.g., every minute) learn a performance target 126 that is transmitted to instances of the network service 104 in the application 102. The instances of the network service 104 utilize the performance target 126 to satisfy the SLO 118 while at the same time minimizing resource utilization, in an embodiment. The performance target 126 learned by the ML model 116 assists the heuristic-based approach utilized by the service-level controller 114 in the manner described below. In particular, the performance target 126 acts as a proxy metric for another metric (e.g., latency in responding to requests 108 in a time-varying network workload) that guides local resource control by the service-level controller 114.

The ML model 116 is a reinforcement learning ML model in various embodiments disclosed herein. In some embodiments, the reinforcement learning ML model is a contextual bandits ML model. In this regard, it is to be appreciated that other types of ML models 116 and other types of reinforcement learning ML models may be utilized in other embodiments including one-armed or multi-armed bandit ML models.

In an embodiment, the ML model 116 learns the performance target 126 based on the SLO 118, network workload attributes 115 that describe characteristics of a time-varying network workload directed to the application 102, and resource allocation data 124 that describes a current allocation of a computing resource (e.g., a CPU) to a network service 104A. As discussed briefly above, the SLO 118 defines a maximum latency for providing responses 110 to requests 108 in the network workload, in an embodiment. The instance of the service-level controller 114 periodically transmits the resource allocation data 124 to the application-level controller 112.

In an embodiment, which is illustrated in FIG. 1B, the network workload attributes 115 utilized by the ML model 116 include a workload measure 120 and latency statistics 122. The workload measure 120 defines an average number of requests 108 per second (“RPS”) in the network workload, in an embodiment. The latency statistics 122 define an average latency for providing responses 110 to requests 108 in the network workload during a previous time period (e.g., the previous second) in this embodiment.

In the illustrated embodiment, a network gateway 106 receives the time-varying network workload, including the requests 108 and responses 110, generates the network workload attributes 115, and provides the network workload attributes 115 to the application-level controller 112. The network workload attributes 115 are obtained from another source in other embodiments.

As shown in FIG. 1B, and discussed briefly above, in one embodiment the managed computing resource is the CPU 128, or CPUs 128, of the computing device 138 that is executing the network service 104A. In this embodiment, the performance target 126 is a CPU throttle target. A CPU throttle occurs when the execution of an instance of a network service 104A is stopped by the underlying CPU scheduler 130. In an embodiment, the CPU throttle target is expressed as a CPU throttle ratio that defines the fraction of time during which execution of the instance of the network service 104A is stopped by the CPU scheduler 130.

The service-level controller 114 receives the performance target 126 from the application-level controller 112. The service-level controller 114 then adjusts the allocation of the computing resource (i.e., the CPU 128 in the embodiment illustrated in FIG. 1B) to the instance of the network service 104A based on the performance target 126 and resource utilization data 119 associated with the execution of the network service 104A.

In the embodiment shown in FIG. 1B, the resource utilization data 119 describes the current CPU throttle count 134 for the CPU 128 upon which the instance of the network service 104A is executing. The CPU throttle count 134 defines the number of times during which the execution of the instance of the network service 104A is stopped by the CPU scheduler 130 during a time period. In this embodiment, the resource allocation data 124 describes the current allocation of the CPU 128, or CPUs 128, to the instance of the network service 104A.

In order to adjust the allocation of the computing resource to the instance of the network service 104A, the service-level controller 114 performs a comparison between the resource utilization data 119 associated with the network service 104A and the performance target 126, in an embodiment. The service-level controller 114 then adjusts the allocation of the computing resource to the instance of the network service 104A based on the results of the comparison.

In an embodiment, the service-level controller 114 transmits an allocation request 117 to an operating system 121 to request an increase in the allocation of the computing resource (i.e., scale up) to the network service 104A when the resource utilization data 119 exceeds the performance target 126. In this embodiment, the service-level controller 114 transmits an allocation request 117 to the operating system 121 to request a decrease (i.e., scale down) in the allocation of the computing resource to the network service 104A when the resource utilization data 119 is less than the performance target 126.

In the embodiment shown in FIG. 1B, the service-level controller 114 transmits a request 117 to the CPU scheduler 130 that requests an increase in the allocation of the CPU 128 to the network service 104A when the CPU throttle count 134 exceeds that specified by the performance target 126. In this embodiment, the service-level controller 114 transmits a request 17 to the CPU scheduler 130 that requests a decrease in the allocation of the CPU 128 to the network service 104A when the CPU throttle count 134 does not exceed that specified by the performance target 126. Additional details regarding this process will be provided below.

Although not illustrated in the FIGS., it is to be appreciated that, in some embodiments, aspects of the present disclosure are implemented in a mobile edge computing (“MEC”) environment implemented in conjunction with a 4G, 5G, or other cellular network. MEC is a type of edge computing that uses cellular networks and 5G and enables a data center to extend cloud services to local deployments using a distributed architecture that provides federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

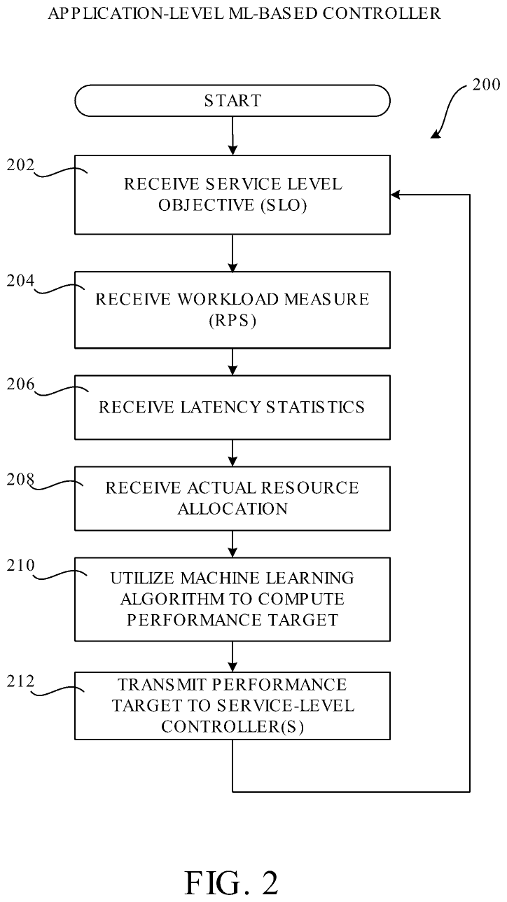

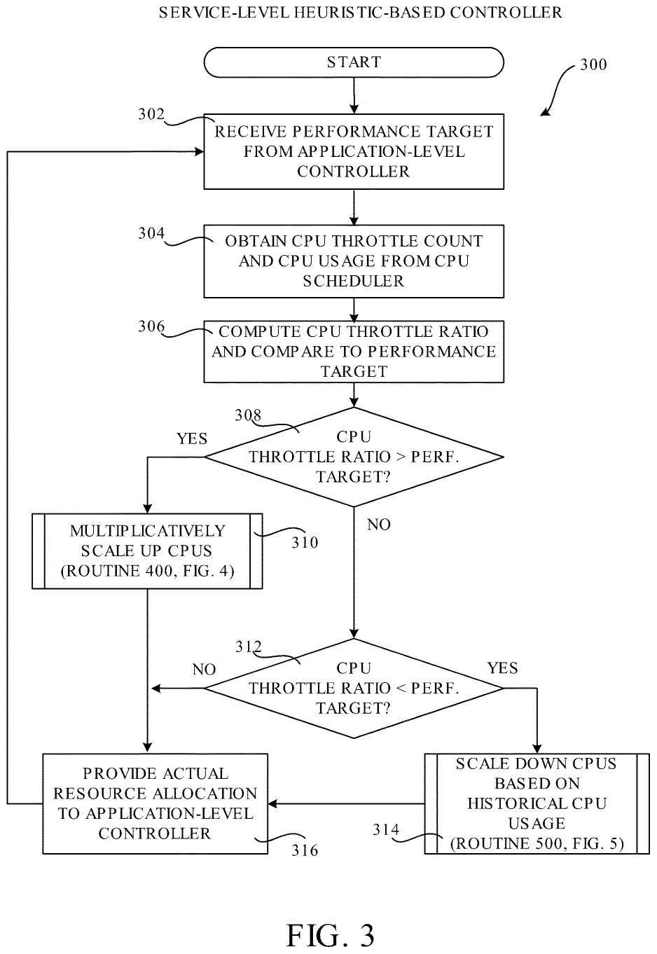

Additional details regarding the operation of the application-level controller 112 are provided below with respect to FIG. 2. Additional details regarding the operation of the service-level controller 114 are provided below with respect to FIGS. 3-6.

FIG. 2 is a flow diagram showing a routine 200 that illustrates additional aspects of the operation of the application-level controller 112 shown in FIGS. 1A and 1B, according to one embodiment disclosed herein. It is to be appreciated that the operations of the routines and methods disclosed herein are not presented in any particular order and that performance of some or all of the operations in an alternative order, or orders, is possible and is contemplated. The operations have been presented in the demonstrated order for ease of description and illustration. Operations may be added, omitted, and/or performed simultaneously, without departing from the scope of the appended claims. The illustrated routines and methods can end at any time and need not be performed in their entireties.

Some or all operations of the methods, and/or substantially equivalent operations, can be performed by execution of computer-readable instructions included on a computer-readable storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations discussed herein can be implemented, at least in part, by modules implementing the features disclosed herein and can be a dynamically linked library (“DLL”), a statically linked library, functionality produced by an application programing interface (“API”), a network service, a compiled program, an interpreted program, a script or any other executable set of instructions. Data can be stored in a data structure in one or more memory components. Data can be retrieved from the data structure by addressing links or references to the data structure.

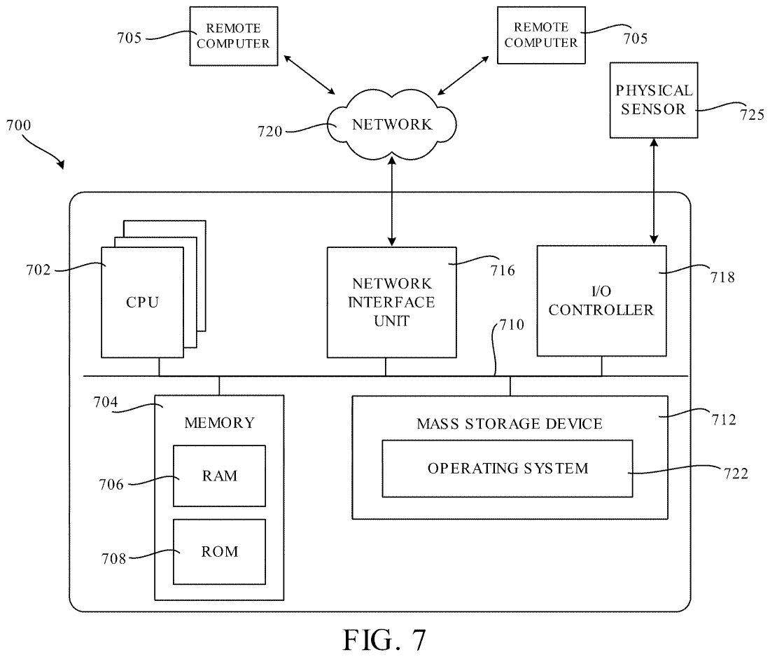

Although the following illustration refers to the components of the FIGS., it can be appreciated that the operations of the routine 200 and the other routines disclosed herein may be also implemented in many other ways. For example, the routine 200 and the other routines disclosed herein can be implemented, at least in part, by a processor of another remote computer or a local circuit. In addition, one or more of the operations of the disclosed routines can alternatively or additionally be implemented, at least in part, by a chipset working alone or in conjunction with other software modules. In the example described below, one or more modules of a computing system can receive and/or process the data disclosed herein. Any service, circuit, or application suitable for providing the disclosed techniques can be used in operations described herein. The operations illustrated in FIGS. 2-6 and described below can be performed, for example, by a computing device such as the processing system 700 described below with regard to FIG. 7.

The routine 200 begins at operation 202, where the application-level controller 112 receives the SLO 118. The SLO 118 is user-specified or defined in another manner, according to various embodiments. From operation 202, the routine 200 proceeds to operation 204.

At operation 204, the application-level controller 112 receives the workload measure 120. As discussed above, in one embodiment the workload measure 120 defines an average number of requests 108 per second in a time-varying network workload. As also discussed above, the network gateway 106 generates the network workload attributes 115, including the workload measure 120, and provides the network workload attributes 115 to the application-level controller 112 in an embodiment. The network workload attributes 115 are obtained from another source, or sources, in other embodiments. From operation 204, the routine 200 proceeds to operation 206.

At operation 206, the application-level controller 112 receives the latency statistics 122. As discussed above, the latency statistics 122 define an average latency for providing responses 110 to requests 108 in the network workload during a previous time period (e.g., the previous second), in an embodiment. The network gateway 106 generates the latency statistics 122 and provides the latency statistics 122 115 to the application-level controller 112 in an embodiment. The latency statistics 122 are obtained from another source, or sources, in other embodiments. From operation 206, the routine 200 proceeds to operation 208.

At operation 208, the application-level controller 112 receives the resource allocation data 124 from the service-level controller 114. As discussed above, the resource allocation data 124 describes a current allocation of a computing resource (e.g., a CPU) to a network service 104A. For example, in an embodiment the resource allocation data 124 describes the current allocation of the CPU 128, or CPUs 128, to the instance of the network service 104A. From operation 208, the routine 200 proceeds to operation 210.

At operation 210, the application-level controller 112 utilizes the ML model 116 to compute the performance target 126 based on the SLO 118, the network workload attributes 115, and the resource allocation data 124. In an embodiment, for instance, the ML model 116 computes the performance target 126 based on the SLO 118, the workload measure 120, the latency statistics 122, and the resource allocation data 124. The routine 200 then proceeds from operation 210 to operation 212.

At operation 212, the application-level controller 112 transmits the performance target 126 to the service-level controller 114. As discussed above, and in greater detail below, the service-level controller 114 utilizes the performance target 126 to augment its heuristic-based approach to local resource control.

From operation 212, the routine 200 proceeds back to operation 202, where the process described above can be periodically repeated. For example, the process illustrated in FIG. 2 is be repeated every minute or other time period to generate an updated performance target 126 that reflects the recent nature of the time-varying workload directed to the network service 104A at an application level.

FIG. 3 is a flow diagram showing a routine 300 that illustrates additional aspects of the operation of the service-level controller 114 shown in FIGS. 1A and 1B, according to one embodiment disclosed herein. The routine 300 begins at operation 302, where an instance of the service-level controller 114 receives the performance target 126 from the application-level controller 112.

From operation 302, the routine 300 proceeds to operation 304, where the instance of the service-level controller 114 receives the resource utilization data 119 from the operating system 121, CPU scheduler 130, or other component on the computing device 138 executing the instance of the network service 104A. As discussed above, the utilization data 119 describes the current CPU throttle count 134 for the CPU 128 upon which the instance of the network service 104A is executing, in an embodiment. The service-level controller 114 also obtains the CPU usage 132 from the CPU scheduler 130 at operation 304, in an embodiment.

From operation 304, the routine 300 proceeds to operation 306, where the service-level controller 114 compares the performance target 126 received from the application-level controller 112 to the resource utilization data 119. For example, in an embodiment, the service-level controller 114 computes a current CPU throttle ratio based on the resource utilization data 119 and compares the current CPU throttle ratio to the CPU throttle ratio defined by the performance target 126.

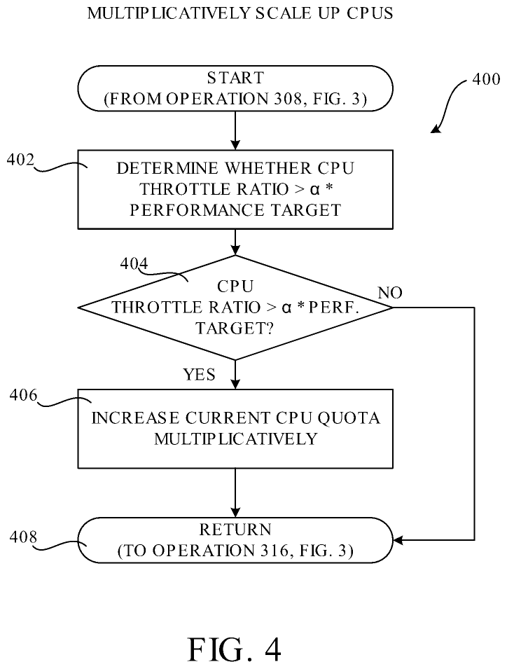

The routine 300 then proceeds from operation 306 to operation 308, where the service-level controller 114 determines if the resource utilization data 119 (e.g., the current CPU throttle ratio) exceeds the performance target 126 (e.g., a desired maximum CPU throttle ratio). If the resource utilization data 119 exceeds the performance target 126, the routine 300 proceeds from operation 308 to operation 310, where the service-level controller 114 increases the allocation of the computing resource (e.g., increases the CPU quota 136) to the network service 104A. As will be described in greater detail below with respect to FIG. 4, the service-level controller 114 multiplicatively increases the allocation of the computing resource to the network service 104A in one embodiment.

If the resource utilization data 119 does not exceed the performance target 126, the routine 300 proceeds from operation 308 to operation 312, where the service-level controller 114 determines if the resource utilization data 119 (e.g., the current CPU throttle ratio) is less than the performance target 126 (e.g., a desired maximum CPU throttle ratio).

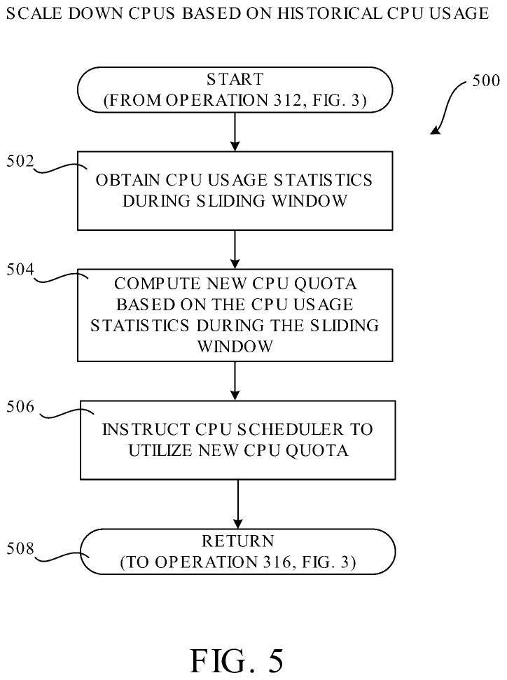

If the resource utilization data 119 is less than the performance target 126, the routine 300 proceeds from operation 312 to operation 314, where the service-level controller 114 decreases the allocation of the computing resource (e.g., decreases the CPU quota 136) to the network service 104A. As will be described in greater detail below with respect to FIG. 5, the service-level controller 114 decreases the allocation of the computing resource to the network service 104A based on historical usage of the computing resource, in one embodiment.

From operations 310 and 314, the routine 300 proceeds to operation 316, where the service-level controller 114 provides the resource allocation data 124 to the application-level controller 112. As discussed above, the resource allocation data 124 describes the current allocation of the CPU 128, or CPUs 128, to the instance of the network service 104A, in an embodiment.

From operation 316, the routine 300 proceeds back to operation 302, where the process described above may be periodically repeated. For example, the illustrated process is repeated every 100 ms.

FIG. 4 is a flow diagram showing a routine 400 that illustrates aspects of the operation of the service-level controller 114 shown in FIGS. 1A and 1B for scaling up the allocation of a computing resource to a network service 104, according to one embodiment disclosed herein. In the illustrated embodiment, the service-level controller 114 multiplicatively increases the allocation of the computing resource (i.e., the CPU 128) to the network service 104A in order to quickly scale up. In this regard, it is to be appreciated that other mechanisms may be utilized in other embodiments that scale up the allocation of the computing resource in another manner.

The routine 400 begins at operation 402, where the service-level controller 114 determines whether the current CPU throttle ratio described above is greater than the performance target 126 multiplied by a customizable weight greater than or equal to one (referred to herein as “a”) that controls the sensitivity to transient spikes in the time-variant network workload.

If the service-level controller 114 determines that the current CPU throttle ratio is not greater than the performance target 126 multiplied by a, the routine 400 returns to operation 316 in FIG. 3, described above. If, however, the service-level controller 114 determines that the current CPU throttle ratio is greater than the performance target 126 multiplied by a, the routine 400 proceeds from operation 404 to operation 406.

At operation 406, the service-level controller 114 increases the CPU quota 136 for the instance of the network service 104A multiplicatively. The multiplier applied by the service-level controller 114 is proportional to the difference between the measured and target CPU throttle ratios, in an embodiment. The routine 400 then proceeds from operation 406 to operation 408, where it returns to operation 316 in FIG. 3, described above.

FIG. 5 is a flow diagram showing a routine 500 that illustrates additional aspects of the operation of the service-level controller 114 shown in FIGS. 1A and 1B for scaling down the allocation of a computing resource, according to one embodiment disclosed herein. In the illustrated embodiment, the service-level controller 114 scales down the allocation of a CPU to a network service 104A based on historical usage of the computing resource. In this regard, it is to be appreciated that other mechanisms may be utilized in other embodiments that scale down the allocation of a computing resource in another manner.

The routine 500 begins at operation 502, where the service-level controller 114 obtains usage statistics for the CPU 128 executing the instance of the network service 104A during a previous time period. In one embodiment, for example, the service-level controller 114 maintains a sliding window of CPU usage during a previous time period, such as the previous 50 ms, or another time period. The routine 500 then proceeds from operation 502 to operation 504.

At operation 504, the service-level controller 114 computes a new CPU quota 136 based on the CPU usage during the previous time period (i.e., the sliding window). In one embodiment, for example, the service-level controller 114 computes the new CPU quota 136 based on two statistics from the sliding window: the maximum CPU usage 132 and the standard deviation of CPU usage 132. Specifically, the next CPU quota 136 is instantaneously set to the maximum CPU usage 132 during the sliding window plus a margin multiplied by the standard deviation of CPU usage 132. The margin is a dynamic parameter greater than or equal to zero that increases when the CPU throttle ratio exceeds the target CPU throttle ratio, and decreases otherwise, in an embodiment.

From operation 504, the routine 500 proceeds to operation 506, where the service-level controller 114 instructs the CPU scheduler 130 to utilize the new CPU quota 136, in an embodiment. The routine 500 then proceeds from operation 506 to operation 508, where it returns to operation 316 in FIG. 3, described above.

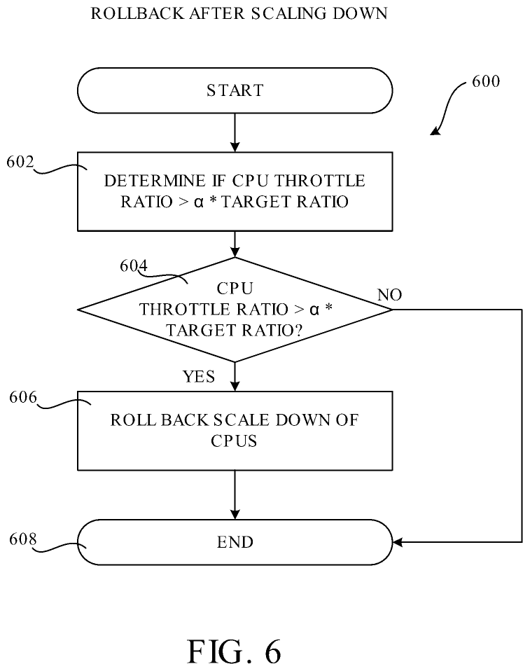

FIG. 6 is a flow diagram showing a routine 600 that illustrates aspects of a mechanism for rolling back operations performed during an inadvertent or problematic scale down of CPUs, according to one embodiment disclosed herein. Unnecessarily scaling down the allocation of a computing resource can lead to violations of the SLO 118 at the application level. In order to address this possibility, the routine 600 provides a mechanism for quickly rolling back the scale-down operations.

The routine 600 begins at operation 602, where the service-level controller 114 determines if the current CPU throttle ratio is greater than a multiplied by the target CPU throttle ratio. If the current CPU throttle ratio is not greater than a multiplied by the target CPU throttle ratio, the routine 600 proceeds from operation 604 to operation 608, where it ends.

If, however, the current CPU throttle ratio is greater than a multiplied by the target CPU throttle ratio, the routine 600 proceeds from operation 604 to operation 606, where the previous scale down of the resource allocation is rolled back. In an embodiment, additional CPU is allocated following the roll back operation to compensate for the inadvertent scale down of the CPU allocation. The routine 600 then proceeds from operation 606 to operation 608, where it ends.

FIG. 7 is a computer architecture diagram showing an illustrative computer hardware and software architecture for a processing system 700 that can implement the various technologies presented herein. In particular, the computer architecture illustrated in FIG. 7 can be utilized to implement a computer capable of providing the functionality disclosed above with reference to FIGS. 1-6.

The processing system 700 illustrated in FIG. 7 includes one or more CPUs 702, a system memory 704, including a random-access memory 706 (“RAM”) and a read-only memory (“ROM”) 708, and a system bus 710 that couples the memory 704 to the CPU 702. A basic input/output system (“BIOS” or “firmware”) containing the basic routines that help to transfer information between elements within the processing system 700, such as during startup, can be stored in the ROM 708.

The processing system 700 further includes a mass storage device 712 for storing an operating system 722, programs such as those described above with respect to FIGS. 1A and 1B, and other types of programs. In one embodiment, a program, or programs, executing on the processing system 700 provides the functionality described above with regard to FIGS. 1A-6. Other modules or program components can provide this functionality in other embodiments. The mass storage device 712 can also be configured to store other types of programs and data.

The mass storage device 712 is connected to the CPUs 702 through a mass storage controller (not shown) connected to the bus 710. The mass storage device 712 and its associated computer readable media provide non-volatile storage for the processing system 700. Although the description of computer readable media contained herein refers to a mass storage device, such as a hard disk, CD-ROM drive, DVD-ROM drive, or USB storage key, it should be appreciated by those skilled in the art that computer readable media can be any available computer-readable storage media or communication media that can be accessed by the processing system 700.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media can include volatile and non-volatile, removable and non-removable media implemented in any method or technology for storage of information such as computer readable instructions, data structures, program modules or other data. For example, computer-readable storage media includes RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the processing system 700. For purposes of the claims, the phrase “computer-readable storage medium,” and variations thereof, does not include waves or signals per se or communication media.

According to various configurations, the processing system 700 can operate in a networked environment using logical connections to remote computers 705 through a network such as the network 720. The processing system 700 can connect to the network 720 through a network interface unit 716 connected to the bus 710. It should be appreciated that the network interface unit 716 can also be utilized to connect to other types of networks and remote computer systems.

The processing system 700 can also include an input/output controller 718 for receiving and processing input from a number of other devices, including a keyboard, mouse, touch input, an electronic stylus (not shown in FIG. 7), or a physical sensor 725 such as a video camera. Similarly, the input/output controller 718 can provide output to a display screen or other type of output device (also not shown in FIG. 7).

It should be appreciated that the software components described herein, when loaded into the CPUs 702 and executed, can transform the CPUs 702 and the overall processing system 700 from a general-purpose computing device into a special-purpose computing device customized to facilitate the functionality presented herein. The CPUs 702 can be constructed from any number of transistors or other discrete circuit elements, which can individually or collectively assume any number of states.

More specifically, each CPU 702 can operate as a finite-state machine, in response to executable instructions contained within the software modules disclosed herein. These computer-executable instructions can transform each CPU 702 by specifying how the CPU 702 transitions between states, thereby transforming the transistors or other discrete hardware elements constituting the CPU 702.

Encoding the software modules presented herein can also transform the physical structure of the computer readable media presented herein. The specific transformation of physical structure depends on various factors, in different implementations of this description. Examples of such factors include the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the processing system 700 in order to store and execute the software components presented herein. It also should be appreciated that the architecture shown in FIG. 7 for the processing system 700, or a similar architecture, can be utilized to implement other types of computing devices, including hand-held computers, video game devices, embedded computer systems, mobile devices such as smartphones, tablets, alternate reality (“AR”) and virtual reality (“VR”) devices, and other types of computing devices known to those skilled in the art. It is also contemplated that the processing system 700 might not include all of the components shown in FIG. 7, can include other components that are not explicitly shown in FIG. 7, or can utilize an architecture completely different than that shown in FIG. 7.

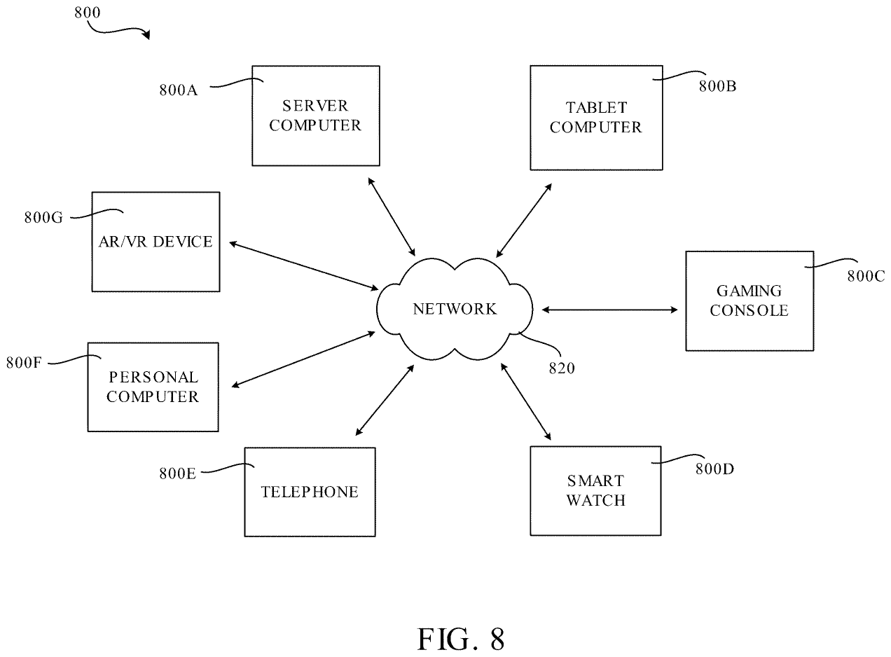

FIG. 8 is a network diagram illustrating a distributed network computing environment 800 in which aspects of the disclosed technologies can be implemented, according to various embodiments presented herein. A distributed computing network 800 such as that shown in FIG. 8 can implement the functionality provided by the multi-tenant cloud environment 100 described above with respect to FIGS. 1A and 1B.

As shown in FIG. 8, one or more server computers 800A can be interconnected via a communications network 820 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as a tablet computer 800B, a gaming console 800C, a smart watch 800D, a telephone 800E, such as a smartphone, a personal computer 800F, and an AR/VR device 800G.

In a network environment in which the communications network 820 is the Internet, for example, the server computer 800A can be a dedicated server computer operable to process and communicate data to and from the client computing devices 800B-800G via any of a number of known protocols, such as, HTTP, file transfer protocol (“FTP”), or simple object access protocol (“SOAP”).

Additionally, the network computing environment 800 can utilize various data security protocols such as secured socket layer (“SSL”) or pretty good privacy (“PGP”). Each of the client computing devices 800B-800G can be equipped with an operating system operable to support one or more computing applications or terminal sessions such as a web browser (not shown in FIG. 8), or other graphical UI, or a mobile desktop environment (not shown in FIG. 8) to gain access to the server computer 800A.

The server computer 800A can be communicatively coupled to other computing environments (not shown in FIG. 8) and receive data regarding a participating user's interactions/resource network. In an illustrative operation, a user (not shown in FIG. 8) interacts with a computing application running on a client computing device 800B-800G to obtain desired data and/or perform other computing applications.

The data and/or computing applications are stored on the server 800A, or servers 800A, and communicated to cooperating users through the client computing devices 800B-800G over an exemplary communications network 820. A participating user (not shown in FIG. 8) requests access to specific data and applications housed in whole or in part on the server computer 800A. These data are communicated between the client computing devices 800B-800G and the server computer 800A for processing and storage.

The server computer 800A can host computing applications, processes, applets, or other types of executable program code for the generation, access, encryption, and communication of data and applications such as those described above with regard to FIGS. 1A-6, and cooperate with other server computing environments (not shown in FIG. 8), third party service providers (not shown in FIG. 8), and network attached storage (“NAS”) and storage area networks (“SAN”) to realize application/data transactions.

It should be appreciated that the computing architecture shown in FIG. 7 and the distributed network computing environment shown in FIG. 8 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method for machine learning (ML)-assisted allocation of a computing resource in a multi-tenant cloud environment comprising a plurality of instances of a network service, an application-level controller that utilizes a ML model to learn a performance target for a network service, and a service-level controller that adjusts an allocation of the computing resource to the network service based on the performance target, the method comprising: receiving, at the application-level controller, attributes of a network workload, resource allocation data describing the allocation of the computing resource to an instance of the network service, and a service-level objective (SLO); learning the performance target for the instance of the network service, by the ML model, based, at least in part, on the attributes of the network workload, the resource allocation data, and the SLO; receiving the performance target at the service-level controller; obtaining, by the service-level controller, resource utilization data associated with the instance of the network service; and adjusting the allocation of the computing resource to the instance of the network service, by the service-level controller, based, at least in part, on the performance target and the resource utilization data associated with the instance of the network service.

Clause 2. The computer-implemented method of clause 1, wherein adjusting the allocation of the computing resource to the instance of the network service comprises: performing a comparison between the resource utilization data associated with the instance of the network service and the performance target; and adjusting the allocation of the computing resource to the instance of the network service based on the comparison.

Clause 3. The computer-implemented method of any of clauses 1 or 2, wherein adjusting the allocation of the computing resource to the instance of the network service based on the comparison comprises increasing an allocation of the computing resource to the instance of the network service responsive to determining that the resource utilization data exceeds the performance target.

Clause 4. The computer-implemented method of any of clauses 1-3, wherein adjusting the allocation of the computing resource to the instance of the network service based on the comparison comprises decreasing an allocation of the computing resource to the instance of the network service responsive to determining that the resource utilization data does not exceed the performance target.

Clause 5. The computer-implemented method of any of clauses 1-4, wherein the computing resource comprises a central processing unit (CPU), wherein the performance target comprises a CPU throttle target, wherein the resource utilization data comprises a CPU throttle count, and wherein the resource allocation data describes the allocation of the CPU to the instance of the network service.

Clause 6. The computer-implemented method of any of clauses 1-5, wherein the instance of the network service operates in a mobile edge computing (“MEC”) environment implemented in conjunction with a 5G cellular network.

Clause 7. The computer-implemented method of any of clauses 1-6, wherein the SLO defines a maximum latency for providing responses to requests in the network workload, and wherein the attributes of the network workload comprise a workload measure defining an average number of requests per second in the network workload and latency statistics defining an average latency for providing responses to requests in the network workload during a previous time period.

Clause 8. A computer-readable storage medium having computer-executable instructions stored thereupon which, when executed by one or more computing devices, cause the one or more computing devices to: execute an application-level controller that utilizes a reinforcement machine learning (ML) model to learn a performance target for an instance of a network service based, at least in part, on attributes of a time-varying network workload that includes requests for the instance of the network service, resource allocation data describing an allocation of a computing resource to the instance of the network service, and a service-level objective (SLO) that defines a maximum latency for providing responses to the requests in the time-varying network workload; and execute a service-level controller that adjusts the allocation of the computing resource to the instance of the network service based, at least in part, on the performance target and resource utilization data associated with the network service.

Clause 9. The computer-readable storage medium of clause 8, wherein adjusting the allocation of the computing resource to the network service comprises increasing an allocation of the computing resource to the network service responsive to determining that the resource utilization data exceeds the performance target.

Clause 10. The computer-readable storage medium of any of clauses 8 or 9, wherein adjusting the allocation of the computing resource to the network service comprises decreasing an allocation of the computing resource to the network service responsive to determining that the resource utilization data does not exceed the performance target.

Clause 11. The computer-readable storage medium of any of clauses 8-10, wherein the resource allocation data describes an allocation of a central processing unit (CPU) to the instance of the network service.

Clause 12. The computer-readable storage medium of any of clauses 8-11, wherein the attributes of the network workload comprise a workload measure defining an average number of requests per second in the network workload and latency statistics defining an average latency for providing responses to requests in the network workload during a previous time period.

Clause 13. The computer-readable storage medium of any of clauses 8-12, wherein the computing resource comprises a central processing unit (CPU), wherein the performance target comprises a CPU throttle target, and wherein the resource utilization data comprises a CPU throttle count.

Clause 14. The computer-readable storage medium of any of clauses 8-13, wherein the reinforcement learning ML model comprises a contextual bandits ML model.

Clause 15. A processing system, comprising: at least one processor; and at least one computer-readable storage medium having computer-executable instructions stored thereupon which, when executed by the at least one processor, cause the processing system to: execute a first controller that utilizes a machine learning (ML) model to learn a performance target for a network service based, at least in part, on attributes of a network workload that includes requests for the network service, resource allocation data describing an allocation of a computing resource to the network service, and a service-level objective (SLO); and execute a service-level controller that adjusts the allocation of the computing resource to the network service based, at least in part, on the performance target and resource utilization data associated with the network service.

Clause 16. The processing system of clause 15, wherein the SLO defines a maximum latency for providing responses to the requests in the network workload.

Clause 17. The processing system of any of clauses 15 or 16, wherein the attributes of the network workload comprise a workload measure defining an average number of requests per second in the network workload and latency statistics defining an average latency for providing responses to requests in the network workload during a previous time period.

Clause 18. The processing system of any of clauses 15-17, wherein the computing resource comprises a central processing unit (CPU), wherein the performance target comprises a CPU throttle target, and wherein the resource utilization data comprises a CPU throttle count.

Clause 19. The processing system of any of clauses 15-18, wherein the resource allocation data describes an allocation of the CPU to the network service.

Clause 20. The processing system of any of clauses 15-19, wherein adjusting the allocation of the computing resource to the network service comprises: increasing an allocation of the computing resource to the network service responsive to determining that the resource utilization data exceeds the performance target; or decreasing an allocation of the computing resource to the network service responsive to determining that the resource utilization data does not exceed the performance target.

Based on the foregoing, it should be appreciated that technologies for ML-assisted management of computing resources have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

1-20. (canceled)

21. A computer-implemented method for machine learning (ML)-assisted allocation of a computing resource in a multi-tenant cloud environment comprising a plurality of instances of a network service, an application-level controller that utilizes a ML model to learn a performance target for a network service, and a service-level controller that adjusts an allocation of the computing resource to the network service based on the performance target, the method comprising:
receiving, at the application-level controller, attributes of a network workload, resource allocation data describing the allocation of the computing resource to an instance of the network service, and a service-level objective (SLO);
learning the performance target for the instance of the network service, by the ML model, based, at least in part, on the attributes of the network workload, the resource allocation data, and the SLO;
receiving the performance target at the service-level controller;
obtaining, by the service-level controller, resource utilization data associated with the instance of the network service; and
adjusting the allocation of the computing resource to the instance of the network service, by the service-level controller, based, at least in part, on the performance target and the resource utilization data associated with the instance of the network service.

22. The computer-implemented method of claim 21, wherein adjusting the allocation of the computing resource to the instance of the network service comprises:
performing a comparison between the resource utilization data associated with the instance of the network service and the performance target; and
adjusting the allocation of the computing resource to the instance of the network service based on the comparison.

23. The computer-implemented method of claim 22, wherein adjusting the allocation of the computing resource to the instance of the network service based on the comparison comprises increasing an allocation of the computing resource to the instance of the network service responsive to determining that the resource utilization data exceeds the performance target.

24. The computer-implemented method of claim 22, wherein adjusting the allocation of the computing resource to the instance of the network service based on the comparison comprises decreasing an allocation of the computing resource to the instance of the network service responsive to determining that the resource utilization data does not exceed the performance target.

25. The computer-implemented method of claim 21, wherein the computing resource comprises a central processing unit (CPU), wherein the performance target comprises a CPU throttle target, wherein the resource utilization data comprises a CPU throttle count, and wherein the resource allocation data describes the allocation of the CPU to the instance of the network service.

26. The computer-implemented method of claim 21, wherein the resource allocation data describes an allocation of a central processing unit (CPU) to the instance of the network service.

27. The computer-implemented method of claim 21, wherein the attributes of the network workload comprise a workload measure defining an average number of requests per second in the network workload and latency statistics defining an average latency for providing responses to requests in the network workload during a previous time period.

28. The computer-implemented method of claim 27, wherein the SLO defines a maximum latency for providing responses to the requests in the network workload.

29. The computer-implemented method of claim 21, wherein adjusting the allocation of the computing resource to the network service comprises increasing an allocation of the computing resource to the network service responsive to determining that the resource utilization data exceeds the performance target.

30. A computer-readable storage medium having computer-executable instructions stored thereupon which, when executed by one or more computing devices, cause the one or more computing devices to:
execute an application-level controller that utilizes a reinforcement machine learning (ML) model to learn a performance target for an instance of a network service based, at least in part, on
attributes of a time-varying network workload that includes requests for the instance of the network service,
resource allocation data describing an allocation of a computing resource to the instance of the network service, and
a service-level objective (SLO) that defines a maximum latency for providing responses to the requests in the time-varying network workload; and
execute a service-level controller that adjusts the allocation of the computing resource to the instance of the network service based, at least in part, on
the performance target and
resource utilization data associated with the network service.

31. The computer-readable storage medium of claim 30, wherein adjusting the allocation of the computing resource to the network service comprises increasing an allocation of the computing resource to the network service responsive to determining that the resource utilization data exceeds the performance target.

32. The computer-readable storage medium of claim 30, wherein adjusting the allocation of the computing resource to the network service comprises decreasing an allocation of the computing resource to the network service responsive to determining that the resource utilization data does not exceed the performance target.

33. The computer-readable storage medium of claim 32, wherein the resource allocation data describes an allocation of a central processing unit (CPU) to the instance of the network service.

34. The computer-readable storage medium of claim 30, wherein the attributes of the network workload comprise a workload measure defining an average number of requests per second in the network workload and latency statistics defining an average latency for providing responses to requests in the network workload during a previous time period.

35. The computer-readable storage medium of claim 30, wherein adjusting the allocation of the computing resource to the instance of the network service comprises:
performing a comparison between the resource utilization data associated with the instance of the network service and the performance target; and
adjusting the allocation of the computing resource to the instance of the network service based on the comparison.

36. A processing system, comprising:
at least one processor; and
at least one computer-readable storage medium having computer-executable instructions stored thereupon which, when executed by the at least one processor, cause the processing system to:
execute a first controller that utilizes a machine learning (ML) model to learn a performance target for a network service based, at least in part, on
attributes of a network workload that includes requests for the network service,
resource allocation data describing an allocation of a computing resource to the network service, and
a service-level objective (SLO); and
execute a service-level controller that adjusts the allocation of the computing resource to the network service based, at least in part, on
the performance target and resource utilization data associated with the network service.

37. The processing system of claim 36, wherein the SLO defines a maximum latency for providing responses to the requests in the network workload.

38. The processing system of claim 36, wherein the attributes of the network workload comprise a workload measure defining an average number of requests per second in the network workload and latency statistics defining an average latency for providing responses to requests in the network workload during a previous time period.

39. The processing system of claim 38, wherein the computing resource comprises a central processing unit (CPU), wherein the performance target comprises a CPU throttle target, wherein the resource utilization data comprises a CPU throttle count, and wherein the resource allocation data describes an allocation of the CPU to the network service.

40. The processing system of claim 39, wherein adjusting the allocation of the computing resource to the network service comprises:
increasing an allocation of the computing resource to the network service responsive to determining that the resource utilization data exceeds the performance target; or
decreasing an allocation of the computing resource to the network service responsive to determining that the resource utilization data does not exceed the performance target.
